(19) United States
(12) Patent Application Publication
(10) Pub. No.: US 2026/0238005 A1
(43) Pub. Date: Aug. 13, 2026

(54) ADAPTIVE REGULATION SCHEMES FOR WIDE-AREA ASSET OVERLOAD PROTECTION

(71) Applicant: Schweitzer Engineering Laboratories, Inc., Pullman, WA (US)

(72) Inventors: Hemanth Kumar Vemprala, Pullman, WA (US); Bharath Nayak, Pullman, WA (US); Pradeep Varma Sangaraju, Pullman, WA (US)

(73) Assignee: Schweitzer Engineering Laboratories, Inc., Pullman, WA (US)

(21) Appl. No.: 19/051,358

(22) Filed: Feb. 12, 2025

(51) Int. Cl. H02J 3/00; H02J 3/06

(52) U.S. Cl. CPC H02J 3/00125; H02J 3/06; H02J 2103/35

(57) ABSTRACT

A protection system for managing overloads in a power transmission network may, for example, include various subsystems to monitor assets, identify overloads, and implement an adaptive regulation scheme (ARS). The ARS scheme includes a hybrid remedial action scheme with a high-speed first protection zone for immediate remedial actions to lower overloads below a transition threshold and a slower, iterative second protection zone that applies remedial actions based on a response-time overload curve to reduce overloads below an operational threshold. The system dynamically prioritizes remedial actions based on real-time conditions and asset dependencies.

### TECHNICAL FIELD

This disclosure relates to power line protection systems, including wide-area protection systems. Specific aspects of this disclosure relate to wide-area networks with heavy power flow, differential protection systems, transmission lines, three-phase power, zone interlocking communication schemes, and recloser controllers.

### BRIEF DESCRIPTION OF THE DRAWINGS

The written disclosure herein describes illustrative embodiments and examples that are nonlimiting and non-exhaustive. This disclosure references some of these embodiments, as depicted in the figures described below.

FIG. 1 illustrates a simplified power system network, according to one embodiment.

FIG. 2 illustrates an example of a static remedial action scheme for a power system, according to one embodiment.

FIG. 3 illustrates an example of a hybrid multizone adaptive regulation scheme (ARS) for a power system, according to one embodiment.

FIG. 4A illustrates a graph of a hybrid multizone ARS response in various overload conditions, according to one embodiment.

FIG. 4B illustrates a graph of the hybrid multizone ARS response with specific shedding and/or regulation actions for an overload condition, according to one embodiment.

FIG. 5 illustrates a flow chart for determining operational parameters of a hybrid multizone ARS for a power system, according to one embodiment.

FIG. 6 illustrates a graph of runback factors of an example transformer in a power system, according to one embodiment.

FIG. 7 illustrates a graph of the loading percentage on various assets in a power system without any remedial action being taken, according to one embodiment.

FIG. 8 illustrates a graph of the load percentage of the same assets in the power system with a hybrid multizone ARS controller, according to one embodiment.

### DETAILED DESCRIPTION

Traditional remedial action schemes used in power transmission systems often rely on static, event-based strategies. For example, a protection system may implement a remedial action scheme that uses a lookup table or other static configuration to react according to a set of predefined contingency conditions. For example, the system may use a lookup table that specifies a remedial action to take in response to a monitored breaker status to prevent a network overload, such as a shedding action, a load-shedding remedial action, a generator runback action, a tie-line control action, an HVDC control action, a shunt switching action, etc. However, static strategies are limited in adaptability and frequently result in over-corrective actions. Static strategies lack the capacity to respond to real-time network dynamics or real-time feedback (e.g., updated load conditions and/or system feedback). According to various embodiments described herein, adaptive regulation schemes accommodate grid expansion, ensuring enhanced network connectivity and maintaining a balanced generation load distribution within evolving power systems.

Transmission networks frequently operate under high power demands, where contingencies like line or transformer failures can cause significant thermal overloads on other parts of the network. For example, when a transmission line goes offline, power may automatically reroute through an alternative path (possibly with higher impedance), causing an overload situation. If an overload protection system does not remediate the overload situation quickly enough, protection devices may be triggered to take portions of the power system offline (e.g., protection devices, such as overload, undervoltage and/or overcurrent protection devices may be triggered). As the triggering of such protection devices is undesirable, a traditional overload protection system operates by detecting an overload condition and implementing a predetermined load-shedding, runback action, or other remedial action (e.g., based on a lookup table). The predetermined action may be overly conservative. For instance, a single, large load-shedding action may not match the severity of the real-time overload and result in excessive load loss.

The presently described systems and methods include a hybrid multizone adaptive regulation scheme (ARS) that implements multiple protection zones to execute both static and dynamic control strategies. In some embodiments, the hybrid multizone ARS includes an adaptive, zone-based remedial action scheme action process in which the protection system transitions between a rapid-response zone under some overload conditions and an iterative load-shedding mode in other overload conditions. The response of the system is based, at least in part, on the real-time severity of detected overloads. For example, the system may continuously monitor power system conditions on one or more assets of a power system, such as power flow, breaker statuses, thermal overload percentages, and the like. The protection system assesses when to engage high-speed remedial actions and when to apply slower, iterative remedial actions. In some embodiments, the protection system may utilize a user-defined or otherwise-specified transition overload threshold value to determine whether to implement a high-speed remedial actions or slower, iterative remedial actions.

The protection system may implement an ARS based on adaptive runback factors for various assets. The adaptive runback factors of the various assets may be used to guide initial, high-speed corrective actions within a first protection zone of the ARS and/or the slower, iterative adjustments in a second protection zone of the ARS. In various embodiments, the runback factors for the various assets are derived from load flow studies used to characterize the relationship between the percentage of overload and the amount of remediation to mitigate the overload. The protection system uses the known runback factors to initiate remedial actions with a high level of precision while minimizing unnecessary or over-corrective actions (e.g., load loss) and providing sufficient remedial action to prevent protection devices from triggering due to overload.

According to various embodiments, a hybrid multizone ARS includes two protection zones. The high-speed first protection zone implements a large-magnitude remedial action to reduce a severe overload condition below a transition threshold. The transition threshold, in some examples, is between approximately 105% and 130% of a maximum loading value of a given asset (e.g., a maximum overload value). Examples of remedial actions include but are not limited to load-shedding actions, runback actions, generator dispatching actions, transformer phase-angle adjustment actions, voltage adjustment actions, and DC tie adjustments.

Once the overload condition is lower than the transition threshold, the protection system shifts to a slower, second protection zone where it applies smaller, incremental remedial actions to reduce the overload condition to below a target operational threshold (e.g., a threshold that is less than the maximum overload value of a given asset). For example, the operational threshold value of a given asset may be between 80% and 95% of the rated operational load of an asset. The gradual approach in the second protection zone allows the system to fine-tune the amount of remediation to minimize impact on power delivery while ensuring system stability.

Moreover, the gradual approach in the second protection zone allows the system to naturally stabilize before taking more drastic remedial actions. In some embodiments, the hybrid multizone ARS integrates feedback mechanisms that allow the system to operate in a closed-loop manner. For example, the hybrid multizone ARS may continually recalibrate the “next” load-shedding (or other remedial action) response based on updated overload measurements. The hybrid multizone ARS allows operators to specify the transition threshold that separates the high-speed first protection zone and the iterative second protection zone, specify the response timing for various overload percentages (e.g., the response timing curve) within the iterative second protection zone, and/or the target operation threshold overload percentage for “normal” or long-term operational states.

In addition to transitioning between the two protection zones, the protection system may also dynamically prioritize remedial actions across multiple assets in the power system based on, for example, dependencies and real-time monitored conditions. For instance, a prioritization subsystem of the protection system may use the interdependencies of assets and/or real-time data to sequence remedial actions. The system may further enhance its response to contingencies through a contingency planning subsystem that identifies potential contingency scenarios and associated response strategies. The contingency planning subsystem identifies a range or set of remedial actions for each contingency scenario. The specific remedial actions and order of implementation may be based on, for example, real-time feedback and a recalculated overload percentage of an overload asset during a response.

To achieve precision and adaptability in overload management, the system may calculate runback factors for different assets based on load flow analysis. These runback factors quantify the relationship between the overload percentage of an asset and the required remedial actions needed to stabilize that asset (e.g., a generator shedding action, a load-shedding remedial action, a generator runback action, a tie-line control action, an HVDC control action, a shunt switching action, etc.). The runback factors may also integrate a safety margin factor, providing a conservative buffer that accounts for potential inaccuracies in overload measurements, particularly during high-stress conditions in the network.

In certain implementations, the system may incorporate a machine learning model to enhance the contingency planning subsystem by identifying patterns in historical data and predicting potential future contingency scenarios. The machine learning model can anticipate scenarios where specific overloads may occur, allowing the system to proactively adjust prioritized actions and/or prepare response strategies for likely events.

The system may also include an interface to allow operators to customize parameters for the transition threshold, operational threshold, and response timing within each protection zone, for each respective asset or set of assets. Operators may define parameters to allow the system to flexibly respond to different operational needs, seasonal load variations, emergency situations, and/or changes in power system topology.

The term intelligent electronic device “IED” may refer to any microprocessor-based device that monitors, controls, automates, and/or protects monitored equipment within a system. Such devices may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communications processors, computing platforms, programmable logic controllers (PLCs), programmable automation controllers, input and output modules, motor drives, controllers for a wide-area monitoring system (WAMS), remedial action scheme or special protection scheme (SPS) controllers, and the like. IEDs may be connected to a network, and communication on the network may be facilitated by networking devices including, but not limited to, multiplexers, routers, hubs, gateways, firewalls, and switches. Furthermore, networking and communication devices may be incorporated into an IED or be in communication with an IED.

The embodiments of the disclosure can be understood by reference to the drawings, wherein like parts are designated by like numerals throughout. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order or even sequentially, nor need the steps be executed only once unless otherwise specified.

Several aspects of the embodiments described may be implemented as software modules, hardware components, and/or combinations thereof. As used herein, a software module or component may include any type of computer instruction or computer executable code located within a memory device and/or transmitted as electronic signals over a system bus or wired or wireless network. A software module or component may, for instance, comprise one or more physical or logical blocks of computer instructions. Software modules or components may comprise disparate instructions stored in different locations of a memory device, which together implement the described functionality of the module. Indeed, a module or component may comprise a single instruction or many instructions and may be distributed over several different code segments, among different programs, and across several memory devices. Some embodiments may be practiced in a distributed computing environment.

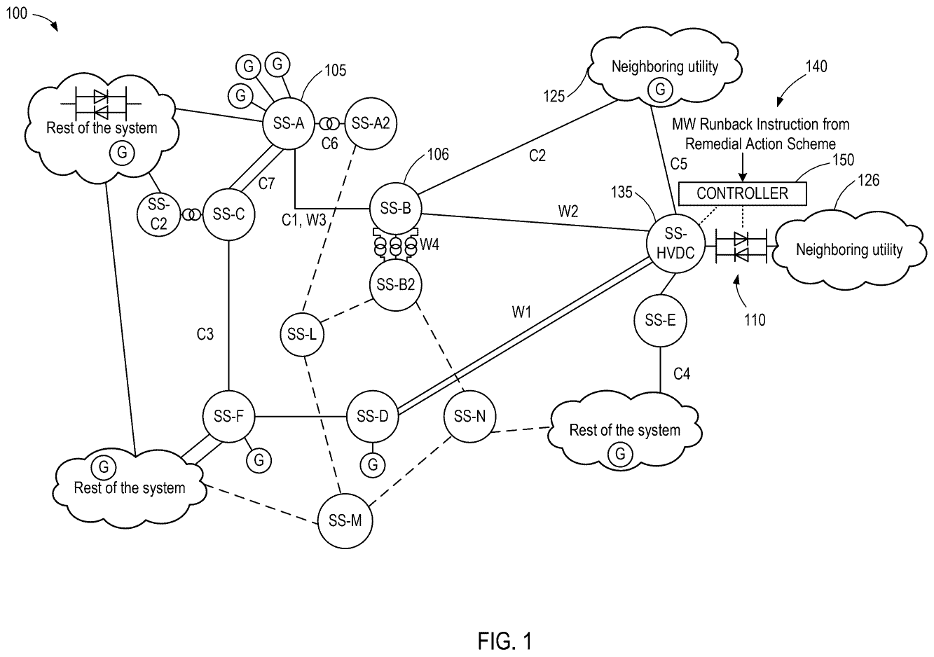

FIG. 1 illustrates a block diagram of a simplified power system network 100 with a High Voltage Direct Current (HVDC) runback as a remedial action mechanism, according to one embodiment. The power system network 100 comprises several interconnected subsystems and assets that may be monitored and controlled by a protection system, such as a protection system implementing an adaptive regulation scheme (ARS). Examples of illustrated assets include transmission lines linking substations, HVDC tie lines 110 for high-speed corrective action, and monitoring points at various load-bearing nodes. Each asset serves a distinct role in the power flow delivery, management, and overload control.

Each substation, such as substation SS-A 105 and substation SS-B 106, is interconnected with neighboring utilities 125 and 126. As illustrated, the substations 105 and 106 are also connected to the external grid, various transmission lines, DC ties, and/or other assets. The various connections, including tie points to neighboring utilities 125 and 126, form potential pathways for power rerouting under contingency events. The contingency assets labeled as “C” elements, such as the example transmission line between substation SS-A 105 and substation SS-B 106, are protected and monitored. The contingency assets can have a high impact on overload conditions in interconnected assets labeled as “W” elements, including transmission lines W1, W2, W3, and W4.

The protection system, including the ARS subsystem 140 and the controller 150, enables rapid response to a wide variety of contingencies by dynamically adjusting power flows. The high-speed, first protection zone protection system of the ARS subsystem 140 may use stored runback factors for various assets to determine remedial actions. The remedial actions mitigate thermal overload risks by redistributing power away from overloaded lines or substations. Remedial actions may be implemented with respect to other assets in the power system network 100 based on system metrics gathered from various intelligent electronic devices (IEDs) associated with various assets (e.g., transmission lines, substations, etc.), which collect real-time data on breaker statuses, power flows, loading conditions, and the like.

The protection system uses the dynamically evaluated real-time loading conditions of the impacted assets to adjust HVDC tie flows and/or execute runback actions when needed (and/or implement other remedial actions). The protection system, as described herein, implements a closed-loop, adaptive control strategy for managing overloads without relying solely on predetermined event-based actions.

The protection system may, for example, include an ARS subsystem 140 to determine closed-loop DC-tie runback actions to reduce the overload percentage of an overloaded asset using a hybrid remedial action scheme. As described herein, the hybrid remedial action scheme may include a high-speed, first protection zone and a slower, iterative second protection zone. Instructions for remedial actions (e.g., DC-tie runback actions) may be implemented by the controller 150. As described herein, the high-speed, first protection zone determines an immediate runback instruction to reduce an overload percentage of an overloaded asset to be less than a transition threshold. The slower, iterative second protection zone then determine a series of iterative DC-tie runback actions (e.g., according to a response-time overload curve). The determined DC-tie runback actions are selected to iteratively reduce the overload percentage of the overloaded asset below an operational threshold. Each successive runback action may be modified or dynamically adjusted based on real-time measurements.

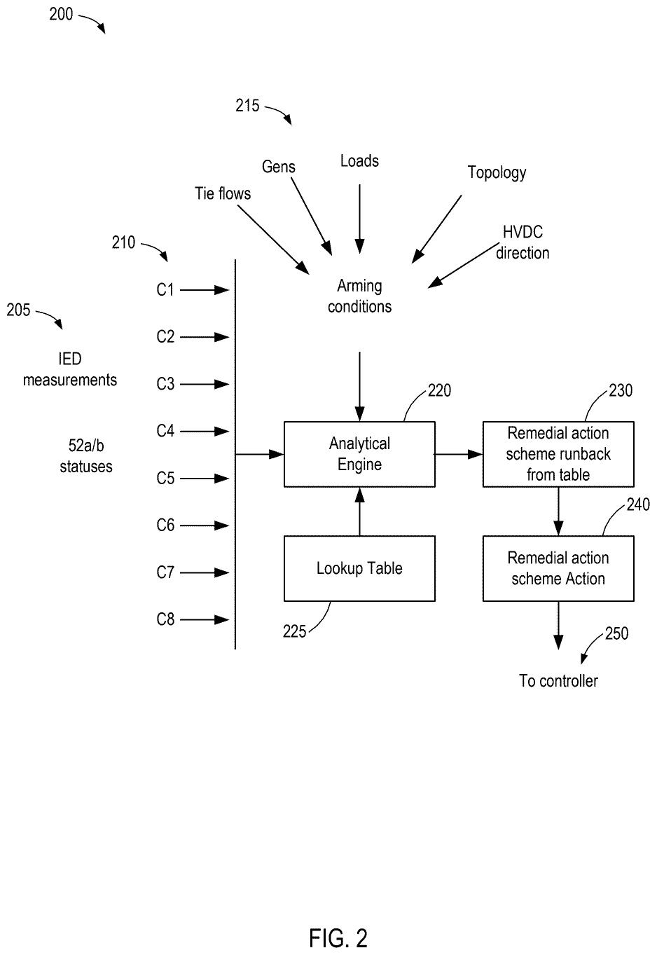

FIG. 2 illustrates an example block diagram of a static remedial action scheme for a power system 200, according to one embodiment. The static remedial action scheme operates based on predefined, static responses to contingency events in the power system. The static remedial action scheme may, for example, rely on a lookup table 225, which associates specific contingency scenarios with predetermined actions to address potential overloads in the network.

The traditional static remedial action scheme operates based on fixed conditions and actions specified in advance, without adapting dynamically to real-time changes in system load or network topology. The static remedial action scheme may rely on data gathered by IEDs 205, that monitor measurements and statuses of key elements or assets of the power system 200 (e.g., the status of breakers or fuses 52a/b) and other contingency indicators 210 across the power system 200. When a contingency event occurs, the IEDs 205 feed status and measurement data into the remedial action scheme system, which assesses conditions using preset arming conditions 215 to determine if a threshold has been met that warrants remedial action.

Once arming conditions 215 are satisfied, the remedial action scheme utilizes an analytical engine 220 to process data according to predefined conditions stored in a lookup table 225. This lookup table 225 cross-references detected contingencies with corresponding remedial action scheme responses, determining a specific runback level or load-shedding action based on the detected contingency and stored values. The remedial action scheme identifies the predetermined remedial action scheme runback action 230 (e.g., a DC-tie runback, load-shedding instruction, etc.), to completely alleviate overload or prevent damage to network elements. That is, the identified remedial action scheme runback action 230 is aggressively computed to immediately reduce an overload percentage of an overloaded asset to be below an operational threshold.

The remedial action scheme action 240 is communicated to the controller 250 for implementation. The controller 250 then executes the action, such as adjusting HVDC tie flows or shedding specific loads, to immediately mitigate the detected contingency. The traditional static remedial action scheme operates in an open-loop mode where each action is executed without ongoing feedback from the system 200. The identified and implemented runback action 230 is intended to immediately mitigate the contingency, which may result in over-corrective responses. The over-corrective response may not be necessary and may not align with real-time measurements and updated conditions within the power system 200. The static protection system implements rigid actions based solely on static values in the lookup table 225. Consequently, while the static system provides some level of overload protection, it does not optimize actions based on real-time conditions, which results in inefficiencies, over-corrective actions, and reliability issues.

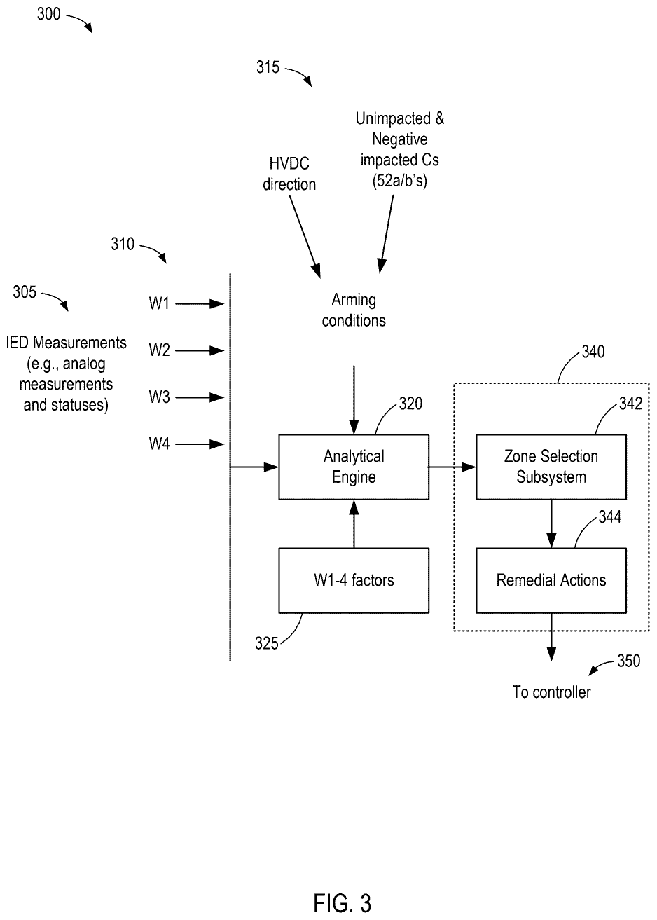

FIG. 3 illustrates an example of a hybrid multizone adaptive regulation scheme (ARS) for a power system 300, according to one embodiment. A power system 300 includes a protection system 340 that implements a hybrid ARS with a multizone remedial action scheme. The protection system 340 dynamically responds to real-time overload conditions by integrating both high-speed, immediate responses and slower, iterative corrections to efficiently manage contingencies and maintain stability in the network.

The power system 300 is monitored by IEDs 305 positioned at critical assets such as transmission lines, substations, and transformers (e.g., assets labeled W1 through W4, 310). The IEDs 305 continuously gather analog measurements and status information, such as real-time power flows, breaker statuses, and loading percentages, and the like. The IEDs 305 may monitor any of a wide variety of system conditions including, but not limited to, voltages, currents, a phase angles, real power values, a reactive power values, and/or the like of various assets.

Arming conditions 315 are used to establish criteria used to activate the ARS remedial action scheme. When the arming conditions 315 are met, the analytical engine 320 processes the data from the IEDs 305 to assess overload levels using asset-specific W1-W4 factors 325. The W1-W4 factors 325 may be, for example, runback factors determined through load flow studies, contingency analyses, and/or published data for specific assets and devices within the power system 300. The W1-W4 factors 325 may be used as a quantitative basis to determine the impact of overloads on critical assets within the power system 300. Any number of factors (e.g., W1-WN) may be considered and used by the system.

The hybrid ARS remedial action scheme protection system 340 includes a high-speed first protection zone and a slower, iterative second protection zone. The zone selection subsystem 342 determines which zone of protection should be used to handle a contingency based on an overload percentage of an overloaded asset. Accordingly, the protection system 340 dynamically designates whether to engage the high-speed first protection zone or the slower, iterative second protection zone. The system determines if the overload percentage of an asset exceeds a user-defined transition threshold (e.g., a threshold at which the protection scheme transitions between the first and second zones of protection). If the overload percentage exceeds the transition threshold, the system initially activates the high-speed first protection zone to quickly mitigate the overload by implementing immediate, large-scale remedial actions 344. The rapid response is used to prevent protective elements from being triggered due to extreme overload conditions. Protective elements, such as overload, overcurrent, undervoltage protection devices, breakers, and/or the like, may be triggered due to persistent overload conditions. The controller 350 implements the determined remedial actions 344 to promptly reduce the overload percentage to below the transition threshold, thereby maintaining system stability and preventing protective elements, such as breakers, from being unnecessarily triggered.

For cases where the overload is less severe or has been partially reduced by the initial action, the system transitions to the second protection zone, which applies a slower, iterative response. In the second protection zone, the ARS protection system 340 uses refined remedial actions 344. The refined remedial actions are calculated by the analytical engine 320 based on the W1-W4 factors 325 to iteratively adjust power flows or other required corrective action. The iterative remedial actions are successively implemented by the controller 350 and updated after each remedial action implementation to ensure that the overloaded asset reaches a stable, operational threshold without over-correcting or excessively disrupting power delivery.

The controller 350 may execute remedial actions to alleviate stress on the overloaded asset or assets. Examples of remedial actions, as described herein, include but are not limited to DC tie runbacks, selective load shedding, generation shedding, power redistribution, other runback actions, generator dispatching actions, transformer phase-angle adjustment actions, voltage adjustment actions, DC tie adjustments, and the like. The hybrid multizone approach implements iterative, dynamically updated remedial actions based on evolving real-time conditions within the system 300.

The closed-loop control strategy of the hybrid ARS multizone remedial action scheme balances system stability and power delivery. The protection system 340 ensures reliable performance even during critical contingencies by dynamically adjusting to current system demands. During protection within the second protection zone, an asset may be operated above an operational threshold (even above a 100% overload percentage) for a brief period of time, but below a level at which protection elements might be activated.

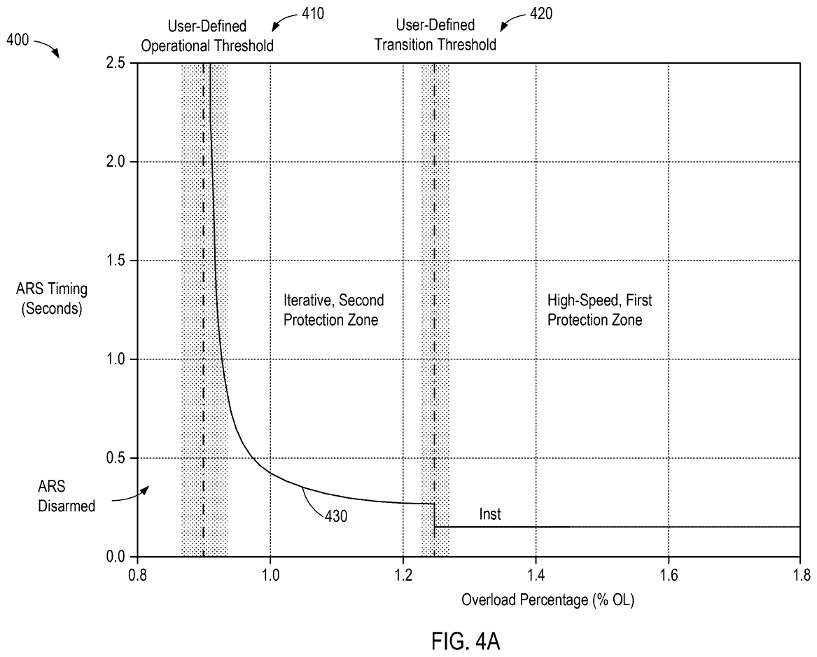

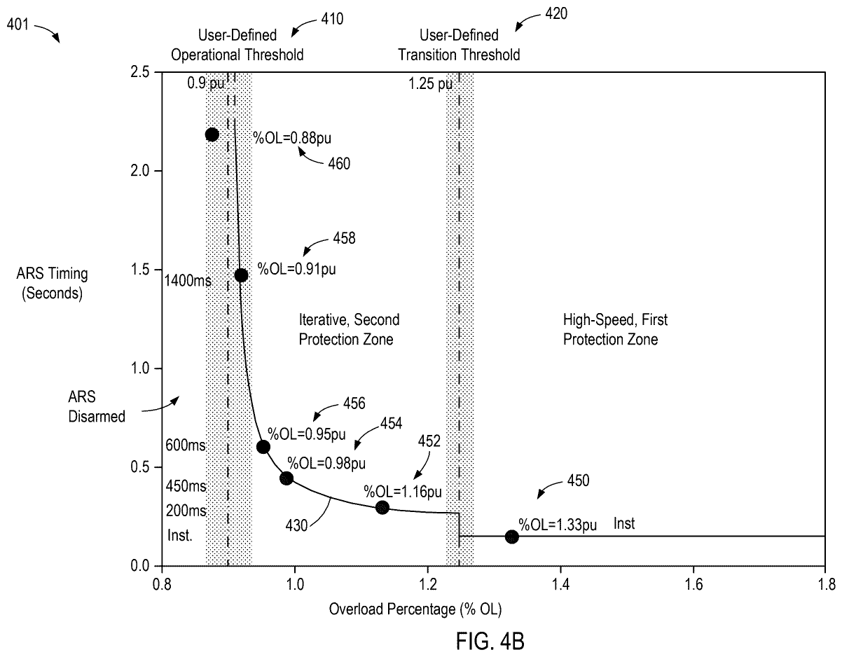

FIG. 4A illustrates a graph 400 of a hybrid multizone ARS response in various overload conditions, according to one embodiment. The graph 400 depicts how the ARS system responds dynamically to differing levels of overload severity in a monitored asset, based on real-time updated information. The horizontal axis represents the percentage of overload in the monitored asset, shown as a percentage value or per-unit (pu) value relative to the asset's rated capacity (as specified by the manufacturer and/or determined during a load or flow study). As overload percentage increases along the horizontal axis, the ARS response adapts accordingly, triggering different levels of intervention. The vertical axis indicates the timing of the ARS response, detailing how quickly the system initiates remedial actions based on the detected overload severity.

The multizone response strategy enables the ARS to react proportionally to the overload severity detected in real time. Faster responses are associated with higher overload conditions to protect system stability. A response-time overload curve 430 is plotted on the graph, which represents the timing characteristics of the ARS as it transitions between different levels of response. This curve reflects the ARS's ability to shift from high-speed, immediate actions (within a high-speed, first protection zone) to slower, iterative interventions (within an iterative, second protection zone), as overload conditions vary.

The transition threshold 420 marks a point along the overload percentage axis, above which the ARS system engages the high-speed, first protection zone. When overload conditions exceed the transition threshold 420, the ARS initiates rapid remedial actions to quickly bring the overload percentage down below the transition threshold. The “immediate” remedial actions implemented within the high-speed, first protection zone represent near-instantaneous, high-speed corrective measures, which, practically speaking, may take some number of milliseconds to be implemented. The immediate remedial actions are intended to prevent protective elements from activating due to extreme overloads. Activation of protective elements is undesirable as it may completely remove power from portions of the system and/or result in cascading contingency events. The immediate remedial actions within the high-speed, first protection zone facilitate a quick reduction in overload conditions to safer levels. The protection system may calculate the magnitude of the immediate remedial action in the first protection zone based on the overload percentage of the overloaded asset, predefined runback factors, and/or a safety margin factor.

As the overload percentage decreases below the transition threshold 420, the ARS moves into a slower, iterative protection zone mode that implements a series of remedial actions to more slowly reduce the operational percentage below the operational threshold 410, which defines a safe operating level for a given asset. The operational threshold 410 represents the overload percentage at which the system or specific assets of the system are considered stable and within acceptable limits. Within the iterative, second protection zone (between the operational threshold 410 and the transition threshold 420, the ARS iteratively applies corrective measures to gradually reduce the overload to achieve a stable operational state while reducing over-correcting and other disruptions to the system performance, as compared to static remedial action scheme approaches.

The adaptive, multizone timing strategy for managing overload conditions dynamically adjusts the recommended remedial actions and the timing between the remedial actions based on the continually updated overload percentage of the asset. The approach balances fast-acting interventions for critical overloads with more measured adjustments as conditions stabilize.

FIG. 4B illustrates a graph 401 of the hybrid multizone ARS response with specific shedding and/or other remedial actions for an overload condition, according to one embodiment. As illustrated, the system transitions from immediate to iterative remedial actions across two protection zones, the high-speed, first protection zone and the iterative, second protection zone. The graph 401 depicts how the ARS dynamically manages overload conditions to stabilize the monitored asset within safe operational limits.

An initial overload condition 450 of 1.33 pu is detected, which exceeds the transition threshold 420. The transition threshold 420 represents an overload level above which the ARS engages its high-speed, first protection zone to immediately reduce the overload percentage. Upon detecting this condition, the ARS initiates a rapid remedial action to bring the overload below the transition threshold 420, aiming to avoid triggering protective elements such as breakers, which could otherwise result in power loss or cascading failures across the network.

After the initial remedial action, the overload percentage is quickly reduced below the transition threshold 420 (e.g. to an overload condition 452 of 1.16 pu), and the protection system enters the slower, iterative second protection zone. In the second protection zone, the ARS applies a series of incremental, timed remedial actions to gradually bring the overload percentage closer to or below the operational threshold 410, which represents the target safe operating level for the asset.

The iterative responses in the second protection zone are shown at various timed intervals as the ARS adaptively (e.g., progressively) reduces the overload condition. A second remedial action is taken at 200 ms to address the overload condition 452 of 1.16 pu. The second remedial action reduces the overload percentage of the asset to 0.98 pu, represented by overload condition 454. The ARS determines a third remedial action that, once implemented at 450 ms, reduces the overload percentage to an overload condition 456 of 0.95 pu. The ARS determines a fourth remedial action for implementation at 600 ms to reduce the overload percentage to an overload condition 458 of 0.91 pu. The ARS determines a fifth remedial action for implementation at 1,400 ms (according to the response-time overload curve 430) to reduce the overload percentage to an overload condition 460 of 0.88 pu, which below the operational threshold. Finally, a stable overload condition 460 of 0.88 pu represents a return to safe operational levels below the operational threshold 410. This final state confirms that the ARS has successfully mitigated the overload without triggering protective elements, and while reducing or minimizing over-corrective actions that would otherwise be taken by a static remedial action scheme.

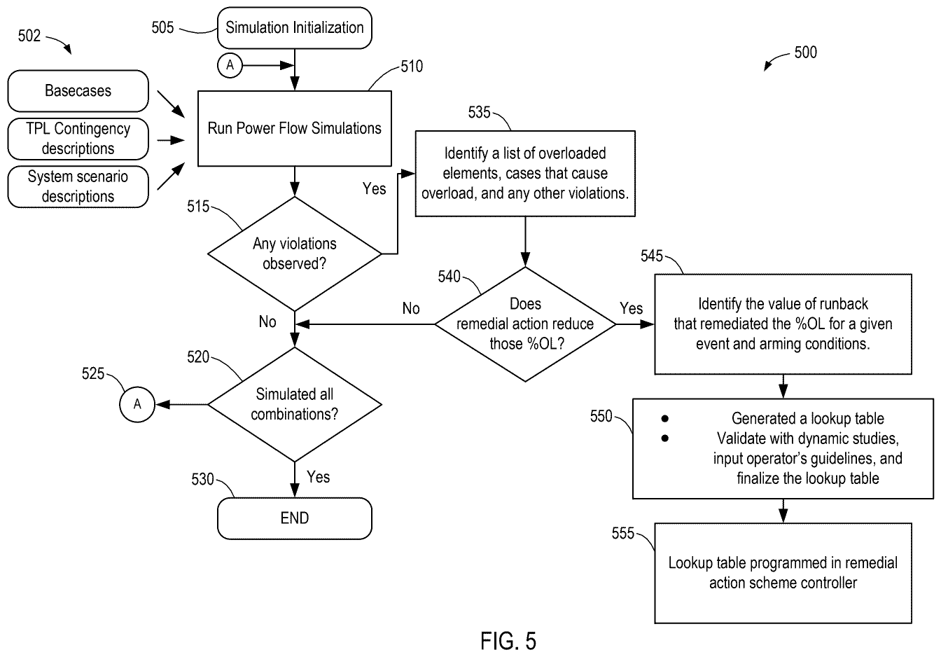

FIG. 5 illustrates a flow chart 500 of a flow study in a power system to determine operational parameters, such as runback factors, to be used by a hybrid multizone ARS, according to one embodiment. The flow study is used to systematically evaluates potential overloads and contingency scenarios to inform the parameters and actions needed within the ARS for reliable overload management. The process begins with inputs 502 that include base cases, transmission planning (TPL) contingency descriptions, and specific system scenario descriptions. The inputs 502 serve as foundational data to initialize the power flow study. A simulation initialization 505 is conducted to set up the power system for flow simulations. For example, the simulation initialization may include the use of any of a wide variety of simulation environments and techniques, including a power system simulator for engineering (PSSE) environment, EMTP software simulations, phaser domain simulation software, etc.

Once the initialization is complete, the study proceeds to run power flow simulations 510, where various contingencies and system scenarios are simulated to observe their effects on the power system. The flow study monitors assets for violations, at 515, such overloads or other conditions that exceed operational limits. If a contingency event does not cause any violations, at 515, the process continues by determining if all possible combinations have been simulated, at 520. This decision point directs the study flow depending on whether additional combinations of contingencies require evaluation. If all combinations have been assessed, at 520, the process ends, at 530, otherwise, flow study continues at A, 525, by returning to the top of the flow study to run power flow cases, at 510.

For cases where overloads or violations are detected, at 515, the process continues by creating a list, at 535, of overloaded elements, cases that cause these overloads, and any other observed violations. The list serves as the basis for further analysis to ensure effective remedial action planning. The study evaluates, at 540, if a remedial action can reduce the overload percentage of an asset in each case. If not, the study continues by determining if all simulated combinations have been completed, at 520, as described above. If a viable remedial action is identified, at 540, the study continues by identifying the amount of runback that remediates the percent overload for a given event and arming condition, at 545. The study is used to quantify the specific runback values necessary to mitigate the overload for each scenario, establishing the parameters for the ARS.

After determining the required runback amounts, study is used to generate a lookup table 550, where the results are organized into a structured lookup table of runback factors. The table of runback factors correlates contingency events with remedial actions and runback levels for the ARS. The lookup table 550 may be validated against dynamic studies and/or refined based on operator guidelines to ensure practical applicability and reliability in real-world conditions. Once validated and refined, the lookup table is finalized. The final lookup table represents a resource that translates the flow study results into actionable control instructions.

The lookup table may be programmed, at 555, into the remedial action scheme controller. The integrated lookup table is used by the remedial action scheme controller to implement the predetermined actions in response to detected contingencies, guided by the parameters and runback factors established by the flow study.

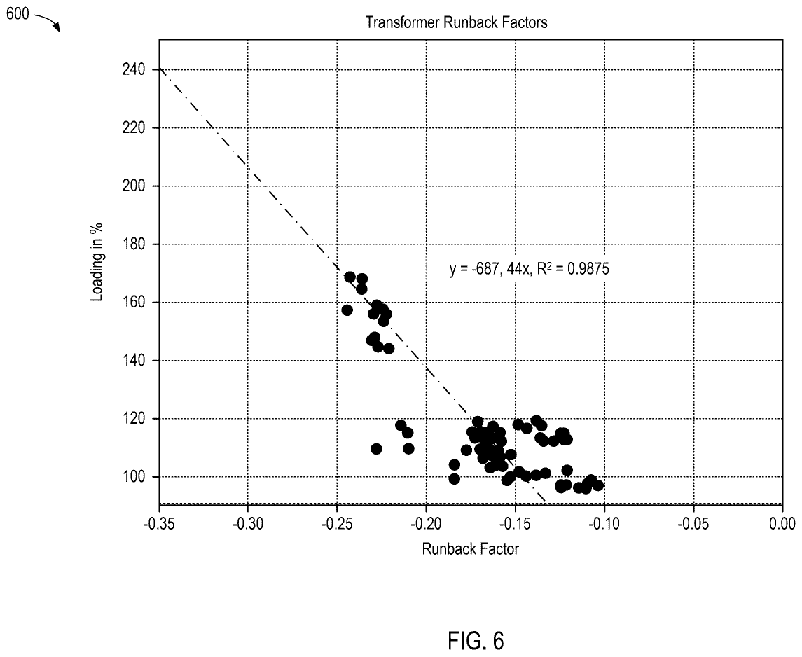

FIG. 6 illustrates a graph 600 of runback factors of an example transformer in a power system, according to one embodiment. The graph 600 characterizes the relationship between the transformer's loading percentage, shown on the vertical axis, and the runback factor, represented on the horizontal axis. This relationship helps determine the corrective action required to reduce the transformer's overload level efficiently.

The vertical axis represents the transformer's loading as a percentage, with higher percentages indicating more significant overload conditions. The horizontal axis shows the runback factor, which quantifies the level of load reduction needed to remediate the overload. A line of best fit, derived from multiple data points, indicates a nearly linear relationship between runback factors and the resulting decrease in transformer loading. The linear relationship is used to determine the appropriate level of runback needed in various overload scenarios. An ARS protection system uses the information to accurately scale remedial actions based on the severity of the overload and adaptively respond to real-time conditions.

As an example, a transformer may experience an overload condition due to high power flow. The ARS protection system is configured with user-defined parameters, such as the operational threshold and the transition threshold separating the high-speed first protection zone and the slower, iterative second protection zone. The ARS protection system may also utilize runback factors associated with the overloaded transformers (e.g., based on a load flow analysis and/or other contingency studies, as described below). The specific examples and values below are used to illustrate a possible operation of an ARS protection system. The ARS protection system may be configured to operate in a first protection zone when the overload percentage of the transformer exceeds a transition threshold of 110%. The ARS protection system may be configured to operate in a second protection zone when the overload percentage exceeds an operational threshold of 90%. The operational threshold corresponds to a target value for the iterative, slower corrective adjustments in lower-severity overload situations (e.g., within the second zone of protection). According to various embodiments, the ARS protection system identifies the severity of the overload on the transformer to classify the response into the appropriate protection zone based on these predefined thresholds.

The ARS protection system uses known runback factors of the transformer (e.g., a runback factor constant from a power system study) to determine the magnitude of a runback remedial action. The ARS protection system may use the following equation to calculate a runback factor based on a measured overload percentage and a runback factor constant:

$$Calculated Runback Factor = \frac{[ measured \% OL ]}{Runback Factor Constant} \qquad Equation 1$$

For a transformer with an overload percentage of 118% and a runback factor constant of negative 687.44, the ARS protection system would calculate a runback factor of negative 0.17165. The runback factor constant for the transformer may be acquired from a slope analysis of runback factor data, as illustrated in FIG. 6. The ARS protection system determines an amount to runback as follows:

$$A R {S}_{zone 1} = k + \{ [ {HVDC}_{flow} ( MW ) ] - \frac{[ measured \% OL error ]}{Calculated Runback factor} \} \qquad Equation 2$$

The k in Equation 2 represents a safety margin and may be user-defined as any value equal to or greater than zero. The HVDC_{flow}(MW) represents the power transfer between one grid to another grid. For the present example, the HVDC_{flow}(MW) is predefined as −200 MW, where positive and negative values are used to indicate directionality. The measured % OL error is calculated as the difference between the overload condition and the operational threshold. For the example 118% overload condition, the measured % OL error is found as 118%-90%, which is 28. Using the previously calculated runback factor of −0.17165, the amount required for runback in the first zone of protection is calculated as −36.877 MW, plus any safety margin, k. The controller implements the immediate remedial runback action of −36.877+k. The safety margin, k, may be selected based on a minimum block size available for remedial actions, a percentage (e.g., 5%-20%) of the total DC tie flow value, or another value. In some embodiments, the safety margin may operate as a rounding factor instead of as a added value. For example, the safety margin may operate to round up any calculated runback amount to the nearest 10 MW or nearest 50 MW. Again, the rounding value may be based on a minimum block size available for remedial actions, a percentage of the total DC tie flow value, or another value.

The ARS protection system determines an updated overload percentage of the transformer, which is less than the transition threshold, resulting in subsequent remedial actions being implemented via the slower, iterative second protection zone. Operating in the second protection zone, the ARS protection system does not compute the runback value using the equations above. Instead, the ARS protection recursively steps down to the next DC tie level and recalculates the overload percentage. A series of iterative step downs to the DC tie level are implemented until the overload percentage is below the operational threshold.

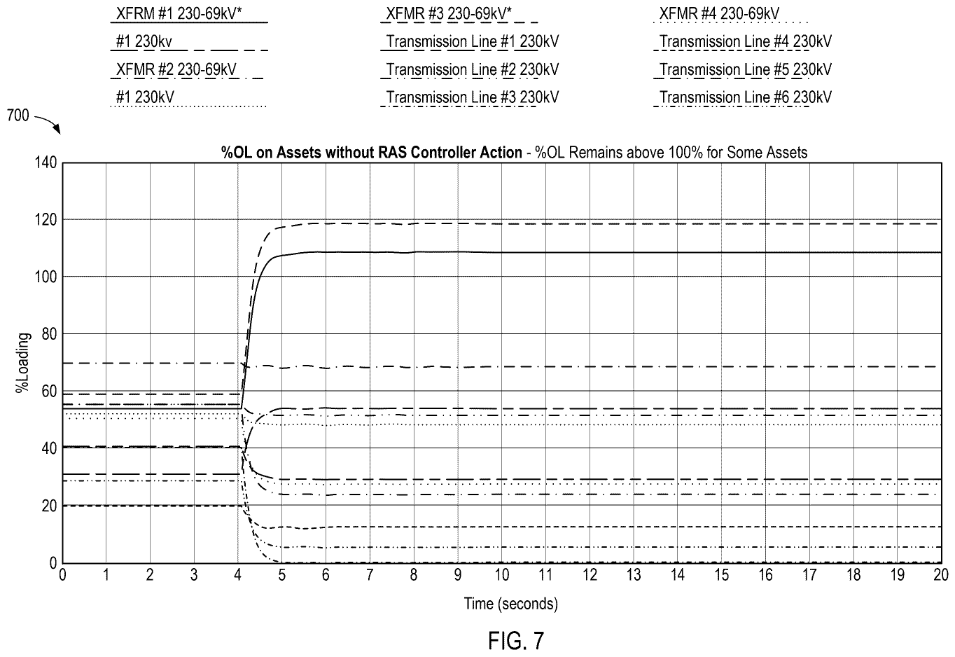

FIG. 7 illustrates a graph 700 of the loading percentage on various assets in a power system without any remedial action being taken, according to one embodiment. The graph 700 illustrates the overload percentage (% OL) with respect to time for various assets within a power system during an example contingency event. As illustrated, prior to time 4 seconds, all assets are operating well below an overload percentage of 80%. The contingency event occurs just after time 4 seconds. As illustrated in the graph 700, the contingency event causes multiple system assets to exceed an overload percentage of 100%.

The vertical axis represents the percentage loading (% OL) for each asset, while the horizontal axis shows time in seconds. Without a remedial action scheme controller to initiate corrective actions, the overloaded assets, such as XFRM #1 and XFMR #3, remain overloaded throughout the duration of the observation period, placing stress on the system and increasing the risk of potential damage, protective device activation, and/or cascading failures.

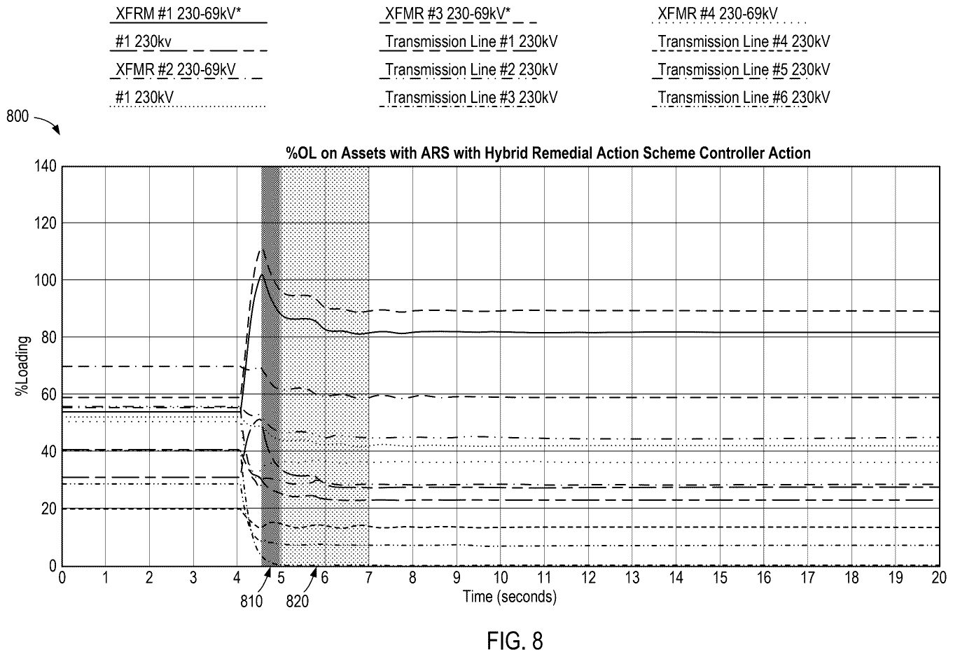

FIG. 8 illustrates a graph 800 of the load percentage of the same assets in the power system with a hybrid multizone ARS controller, according to one embodiment. Again, the vertical axis represents the percentage loading of each element, while the horizontal axis shows time in seconds. The hybrid ARS multizone remedial action scheme protection system responds to the contingency event at time 4 seconds by automatically adjusting the system load via immediate remedial actions followed by a series of slower, iterative remedial actions. The immediate actions operate to quickly reduce the overload percentage within a first zone of protection 810. Subsequent, slower remedial actions are iteratively implemented within a second zone of protection 820.

The remedial actions implemented by the hybrid ARS multizone remedial action scheme protection system reduce the overload percentage of the XFRM #1 and XFMR #3 assets within a few seconds. The decrease in overload percentage of the XFRM #1 and XFMR #3 assets demonstrates the effectiveness of the hybrid ARS multizone remedial action scheme protection system in mitigating overloads by redistributing load across the system. By around the 6-second mark, the overload percentage of the various assets are stabilized well below established operational thresholds. This behavior contrasts with the uncontrolled overloads observed in FIG. 7, underscoring the operation of the ARS-based remedial action scheme in achieving system stability more quickly and efficiently.

The hybrid ARS-based protection approaches described herein are not limited to use in standard overload management scenarios. The various systems and methods described herein can be integrated into high-impact remedial action schemes to address critical contingencies. The adaptive and dynamic response capabilities of the approaches described herein can be used to enhance the reliability and efficiency of high-impact remedial action scheme. Integration in high-impact remedial action scheme allows for seamless handling of severe network events while maintaining operational stability and minimizing disruption.

It is appreciated that two or more of the systems, subsystems, components, modules, etc., that are described herein may be combined as a single system, subsystem, module, or component. Moreover, many of the systems, subsystems, components, and modules may be duplicated or further divided into discrete systems, subsystems, components, or modules to perform subtasks of those described herein. Any of the embodiments described herein may be combined with any combination of other embodiments described herein.

The components of some of the disclosed embodiments are described and illustrated in the figures. herein. Many portions thereof could be arranged and designed in a wide variety of different configurations. Furthermore, the features, structures, and operations associated with one embodiment may be applied to or combined with the features, structures, or operations described in conjunction with another embodiment. In many instances, well-known structures, materials, or operations are not shown or described in detail to avoid obscuring aspects of this disclosure. Many of the illustrations are provided in a block diagram format to illustrate a general configuration and may not be drawn to scale. The right to add any described embodiment or feature to any one of the figures and/or as a new figure is explicitly reserved.

This disclosure has been made with reference to various examples and embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure, along with every permutation of the claims filed herewith.

What is claimed:

1. A protection system, comprising:
a monitoring subsystem to monitor each of a plurality of assets in a power transmission system;
an overload identification subsystem to identify one of the plurality of assets as an overloaded asset based on an overload percentage of the overloaded asset;
an adaptive regulation scheme (ARS) subsystem to determine closed-loop remedial actions to reduce the overload percentage of the overloaded asset according to a hybrid remedial action scheme with:
a high-speed, first protection zone to determine at least one immediate remedial action to reduce the overload percentage of the overloaded asset below a transition threshold, and
a slower, iterative second protection zone to determine a series of iterative remedial actions according to a response-time overload curve to reduce the overload percentage of the overloaded asset below an operational threshold; and
a controller to implement the remedial actions determined by the first and second protection zones of the hybrid remedial action scheme of the ARS subsystem.

2. The protection system of claim 1, wherein the response-time overload curve defines time increments between the iterative remedial actions implemented within the second protection zone based on recalculated overload percentages of the overloaded asset after each remedial action is implemented.

3. The protection system of claim 1, wherein the monitoring subsystem is configured to monitor at least one of a voltage, a current, a phase angle, a real power value, and a reactive power value of each of the plurality of assets.

4. The protection system of claim 1, wherein the transition threshold for each of the monitored assets is set between 105% and 130% of a maximum overload value of each respective asset, and
wherein the operational threshold of each monitored asset is between 80% and 95% of the maximum overload value of each respective asset.

5. The protection system of claim 1, wherein each remedial action is implemented with respect at least one of (i) the overloaded asset and (ii) at least one other asset in the power transmission system, and
wherein each remedial action is implemented with respect to pre-defined runback factors of each respective asset.

6. The protection system of claim 5, wherein the ARS subsystem is configured to calculate a magnitude of the immediate remedial action in the first protection zone based on the overload percentage of the overloaded asset, predefined runback factors, and a safety margin factor.

7. The protection system of claim 1, wherein the transition threshold is based on user-defined parameters, and wherein the transition threshold is adjusted according to seasonal load variations.

8. The protection system of claim 1, further comprising:
a feedback subsystem to monitor real-time effectiveness of each remedial action to recalibrate each iterative remedial action determined by the ARS subsystem within the second protection zone based on recalculated overload percentages of the overloaded asset after implementation of each successive remedial action.

9. The protection system of claim 1, wherein each remedial actions comprises at least one of a load-shedding action, a runback action, a generator dispatching action, a transformer phase-angle adjustment action, a voltage adjustment action, and a DC tie adjustment.

10. A method of adaptive overload mitigation in a power transmission system using a hybrid multizone remedial action system, comprising:
monitoring real-time data of each of a plurality of assets in a power transmission system to determine an overload percentage of each asset;
calculating runback factors for at least some of the assets based on a system load flow analysis, wherein the runback factors quantify a relationship between the overload percentage and remedial runback actions of each respective asset;
identifying one of the assets as an overloaded asset based on the determined overload percentage; and
implementing an adaptive regulation scheme (ARS) to reduce the overload percentage of the overloaded asset by:
operating within a high-speed, first zone of protection, to implement an immediate remedial action to reduce the overload percentage of the overloaded asset below a transition threshold, and
operating within a slower, iterative second zone of protection to implement a series of remedial actions according to a response-time overload curve to reduce the overload percentage of the overloaded asset to be less than an operational threshold.

11. The method of claim 10, wherein the response-time overload curve defines time intervals between each of the iterative remedial actions taken within the second zone of protection, wherein the time intervals are adjusted based on updated overload percentages of the overloaded asset after each remedial action.

12. The method of claim 10, wherein the monitored real-time data includes at least one of a voltage measurement, a current measurement, a phase angle, a real power value, and a reactive power value of each of the plurality of assets in the power transmission system.

13. The method of claim 10, wherein the transition threshold is set between 105% and 130% of a maximum overload capacity of the overloaded asset, and the operational threshold is set between 80% and 95% of the maximum overload capacity of the overloaded asset.

14. The method of claim 10, wherein each remedial action is applied to at least one of (i) the overloaded asset and (ii) at least one other asset in the power transmission system, and wherein each remedial action is based on predefined runback factors for each respective asset.

15. The method of claim 14, further comprising:
calculating a magnitude of the immediate remedial action within the first zone of protection, based on the overload percentage of the overloaded asset, predefined runback factors, and a safety margin factor.

16. The method of claim 10, wherein the transition threshold is defined by user-selected parameters, and further comprising adjusting the transition threshold according to seasonal load variations in the power transmission system.

17. The method of claim 10, further comprising:
monitoring, via a feedback subsystem, an effectiveness of each remedial action in real time, and
recalibrating each successive iterative remedial action within the second zone of protection based on updated overload percentages of the overloaded asset following each prior remedial action.

18. A protection system, comprising:
a contingency planning subsystem to identify potential contingency scenarios involving a plurality of assets in a power transmission system, each contingency scenario associated with a response strategy that includes a plurality of possible remedial actions;
a prioritization subsystem to dynamically adjust a prioritized sequence of the remedial actions for each contingency scenario based on dependencies among the plurality of assets and real-time monitored operational conditions; and
an adaptive regulation scheme (ARS) subsystem to execute the response strategy of an identified contingency scenario in the power transmission system, wherein the response strategy includes implementation of a hybrid remedial action scheme having:
a high-speed, first protection zone to implement at least one immediate remedial action to reduce an overload percentage of an overloaded asset below a transition threshold, and
a slower, iterative second protection zone to implement a series of iterative remedial actions according to a response-time overload curve to reduce the overload percentage of the overloaded asset below an operational threshold.

19. The system of claim 18, further comprising:
a machine learning model to identify patterns in historical contingency data to predict additional contingency scenarios.

20. The system of claim 18, wherein the response-time overload curve defines time increments between the iterative remedial actions taken within the second protection zone based on recalculated overload percentages of the overloaded asset after each remedial action is taken.
